(19) United States
(12) Patent Application Publication
(10) Pub. No.: US 2011/0013603 A1
(43) Pub. Date: Jan. 20, 2011

(54) Techniques for MIMO beamforming for frequency selective channels in wireless communication systems

(76) Inventors: Qinghua Li, San Ramon, CA (US); Xintian E. Lin, Palo Alto, CA (US); Senjie Zhang, Zhongguan Cun (CN); Guangjie Li, Beijing (CN)

Correspondence Address: INTEL CORPORATION;c/o CPA Global, P.O. BOX 52050, MINNEAPOLIS, MN, 55402, US

(21) Appl. No.: 12/460,521

(22) Filed: Jul. 20, 2009

(51) Int. Cl. H04W 4/00; H04B 1/38; H04B 7/02

(52) U.S. Cl. 370/338; 375/219; 375/267

(57) ABSTRACT

An embodiment of the present invention provides an apparatus that may include a transceiver operable as a base station (BS) in a wireless network and adapted for multiple input multiple output (MIMO) beamforming and further adapted for wireless communication with a receiver that feeds back to the transceiver a plurality of beamforming matrixes per subband and interpolates the beamforming matrixes across the subband.

### BACKGROUND

In wireless communications, beamforming with matrix feedback has been used to provide significant improvements. Previously, when beamforming has been used, there was only one beamforming matrix feedback per frequency subband. This causes an approximate 10% performance degradation due to frequency selectivity across the subband. The beamforming matrix is then used for the transmit beamforming for the whole subband. This causes performance degradation because the channel response and thus the ideal beamforming matrix vary across the subcarriers within the subband. This problem gets severe as the subband bandwidth increases.

Thus, a strong need exists for improved techniques for MIMO beamforming for frequency selective channels in wireless communication systems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a frequency selective channel across 72 subcarriers;

FIG. 2 depicts the beamforming angle variation across 72 subcarriers for a 2×2 MIMO channel;

FIG. 3 is an illustration of one beamforming matrix and an interpolated two beamforming matrix according to an embodiment of the present invention;

FIG. 4 provides an illustration of a geodesic on Grassmann manifold according to an embodiment of the present invention;

FIG. 5 illustrates the interpolation in the angle domain and vector domain according to an embodiment of the present invention;

FIG. 6 illustrates feedbacks of a subband over time according to an embodiment of the present invention; and

FIG. 7 provides a channel capacity comparison for weakly correlated 2×2 channels with a single stream transmission according to an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the preset invention may be practiced without these specific details. In other instances, well-known methods, procedures, components and circuits have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Embodiments of the present invention provide schemes that feed back a plurality, such as two, beamforming matrixes per subband and interpolate the beamforming matrixes across the subband. In an embodiment of the present invention, a novel interpolation scheme is provided, which minimizes the interpolation error. A gain of 4.1% is achieved for typical channels under the same feedback overhead. Depending on the system configuration, the whole frequency band may consist of one or multiple subbands.

As set forth above, in existing systems, only one beamforming matrix is fed back per frequency subband. The beamforming matrix is then used for the transmit beamforming for the whole subband. This causes performance degradation because the channel response and thus the ideal beamforming matrix vary across the subcarriers within the subband. This problem gets severe as the subband bandwidth increases.

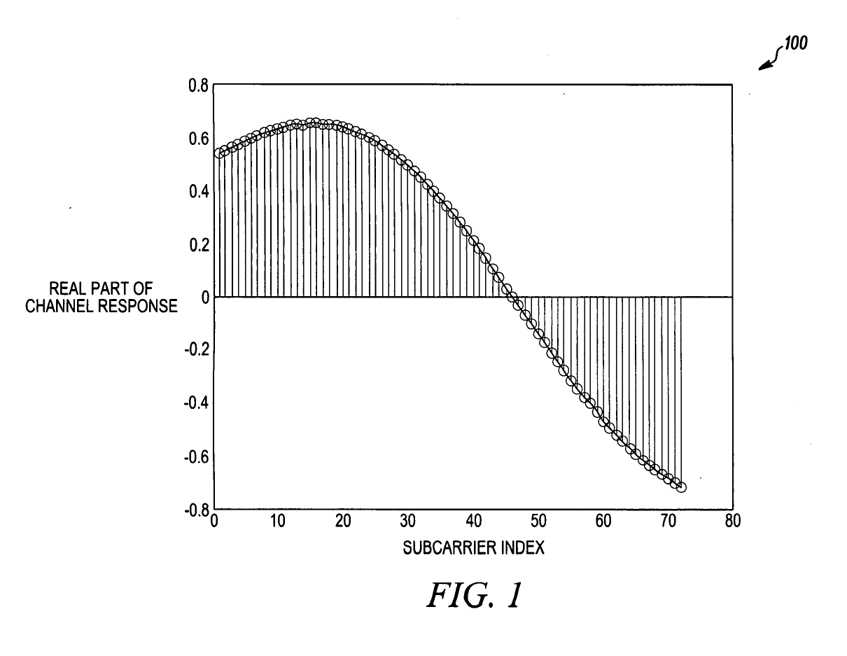

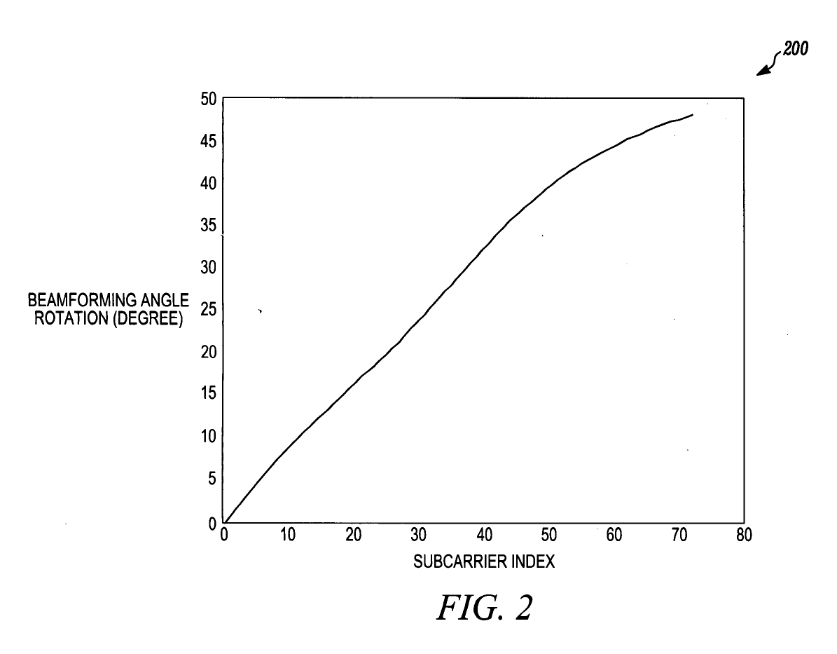

For multiuser multiple input multiple output (MIMO), a large subband width is used to increase the chance of user pairing. Therefore, the subband usually has 72 subcarriers i.e. about 800 kHz. The variation of the channel response within the subband causes the ideal beamforming angle to vary for about 60 degrees for typical channels, which are spatially uncorrelated and spatially weakly correlated MIMO channels. An example of the real part of the channel response is shown in FIG. 1, generally as 100. The corresponding beamforming angle varies across the 72 subcarriers as shown in FIG. 2, generally as 200. The angle variation reduces the beamforming accuracy for the edges of the subband and causes strong interference across users' signals for the downlink of multi-user MIMO. In addition, the variation of the signal quality within the subband may also limit the usage of high rate channel codes. It is desirable to reduce the variation and improve the beamforming accuracy.

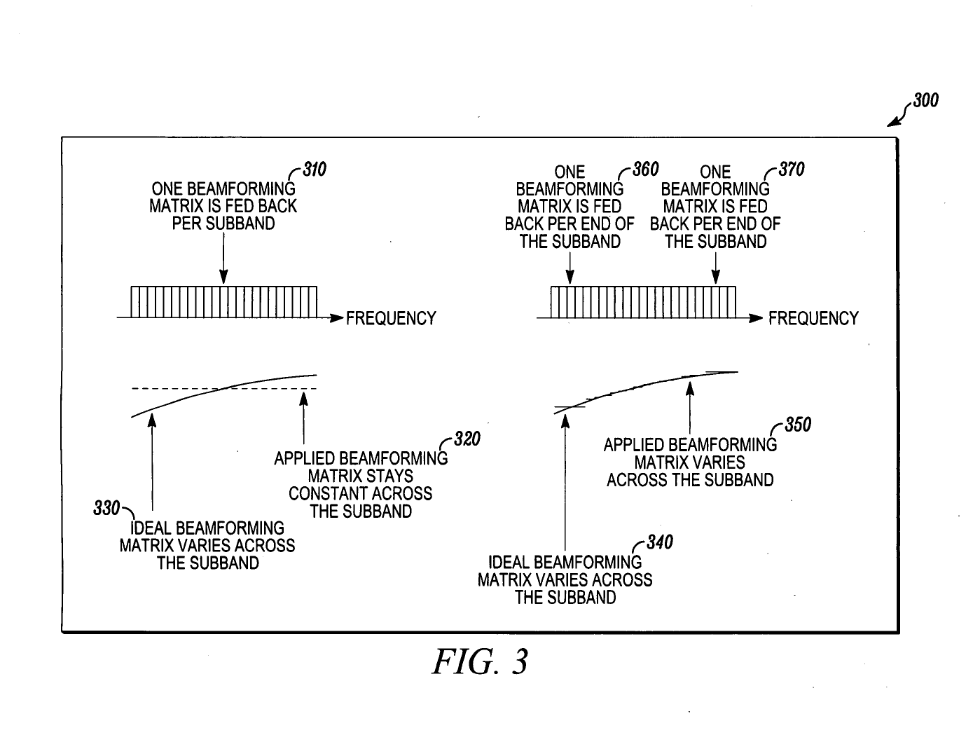

In embodiments of the present invention, instead of one beamforming matrix, the present invention provides feeding back a plurality, such as two, beamforming matrixes. This is particularly useful, if uplink feedback width is available or one user's rough beamforming causes strong interference to the others. It can be an optional configuration for the mobile user to generate two feedbacks per subband. Since the feedback channel can indeed carry more bits for strong users, this option allows the strong users to benefit from their good channels. The two beamforming matrixes are for each of the two ends of subband, respectively. Interpolation may be made for all the beamforming matrixes in the subband using the two fed back matrixes. The applied beamforming matrixes vary across the subband and some embodiments of the present invention select the feedback indexes of the two beamforming matrixes at the two subband ends jointly, taking the interpolation into account. Turning now to FIG. 3 at 300 is an illustration of an embodiment of the present invention and existing arts use of a single beamforming matrix 310, 360 and 370 is illustrated, wherein at 330, 320, 340 and 350 an embodiment of the present invention using a plurality of beam forming matrices with interpolation is shown.

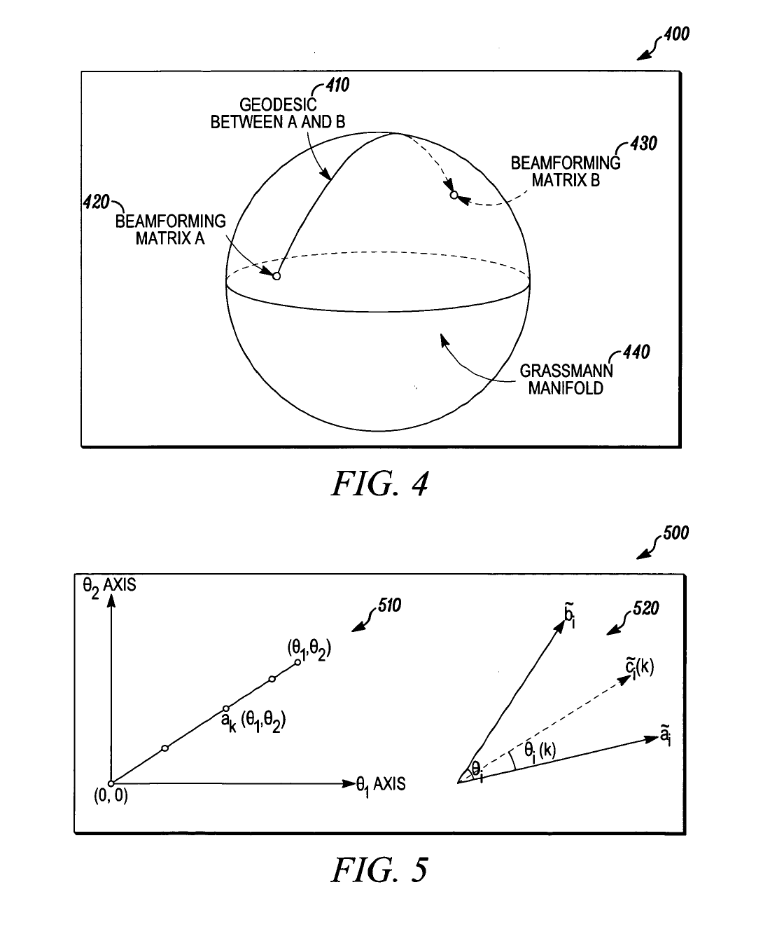

There are multiple ways to interpolate the beamforming matrixes between the two fed back beamforming matrixes. Note that the beamforming matrix is unitary and it is on the Grassmann manifold as shown in FIG. 4, generally shown as 400. There are multiple curves connecting the two fed back matrixes A 410 and B 420 and the interpolated matrixes are on the connecting curve 430. Each curve corresponds to a series of random channel realization. The curve that minimizes the average interpolation error is the geodesic 430 connecting A 410 and B 420.

Let M=A^{H}B, where A and B are the fed back beamforming matrixes; A and B are Nₜ×Nₛ unitary matrixes, i.e. A^{H}A=I and B^{H}B=I; Nₜ is the number of transmit antennas and Nₛ is the number of beamformed streams. Particularly, a single spatial stream is sent and the beamforming matrixes A and B are Nₜ×1 vectors when Nₛ=1. The singular value decomposition of M is given by

M=Q_{A}ΣQ_{B}^{H} (1)

where Q_{A} and Q_{B} are Nₛ×Nₛ orthogonal matrixes and Σ is a diagonal matrix. Let Ã=AQ_{A} and \tilde{B}=BQ_{B}. Then;

$${\tilde{A}}^{H} \tilde{B} = [ \begin{matrix}{σ}_{1} & & \\ & ⋱ & \\ & & {σ}_{{N}_{s}}\end{matrix} ] . \qquad ( 2 )$$

Let σᵢ=cos θᵢ for i=1, . . . , Nₛ. θᵢ is the angle between the i-th column of Ã, denoted by ãᵢ, and the i-th column of \tilde{B}, denoted by \tilde{b}ᵢ, as illustrated on the right in FIG. 4. A linear interpolation is first conducted in the domain of the principal angles θᵢ s as illustrated on the left in FIG. 4. The interpolated angle for the k-th subcarrier is computed as

θᵢ(k)=aₖθᵢ, for i=1, . . . , Nₛ (3)

where

$${a}_{k} = \vert \frac{{f}_{k} - {f}_{A}}{{f}_{A} - {f}_{B}} \vert \qquad ( 4 )$$

is inversely proportional to the frequency spacing between A's subcarrier and B's subcarrier, i.e. |f_{A}-f_{B}| and is proportional to the frequency spacing between A's subcarrier and the k-th subcarrier, i.e. |fₖ-f_{A}|. After the angle is interpolated, a vector \tilde{c}ᵢ(k) interpolated between the i-th column of Ã, ãᵢ, and the i-th column of \tilde{B}, \tilde{b}ᵢ, is computed as illustrated on the right in FIG. 5. The cᵢ(k) has unit norm and stays in the plane spanned by ãᵢ and \tilde{b}ᵢ. In addition, the angle between \tilde{c}ᵢ(k) and ãᵢ is θᵢ(k) . Finally, the interpolated beamforming matrix is formed by

\tilde{C}(k)=[\tilde{c}₁(k) . . . \tilde{c}_{N}_{ₛ}(k)]. (5)

If \tilde{C}(k) is not a unitary matrix, it can be converted to a unitary matrix that spans the same subspace using algorithms such as QR decomposition or Grant-Schmidt operation. In order to minimize the phase transition of the beamforming matrixes across the subband, an Nₛ×Nₛ orthogonal matrix Q(k) can be multiplied from the right to each beamforming matrix including A, B, and \tilde{C}(k)s. For example, \tilde{C}(k) may be converted to C(k) as

C(k)=\tilde{C}(k)Q(k), (6)

where Q(k) may be equal to Q_{A}^{H}; C(k) is used for actual beamforming.

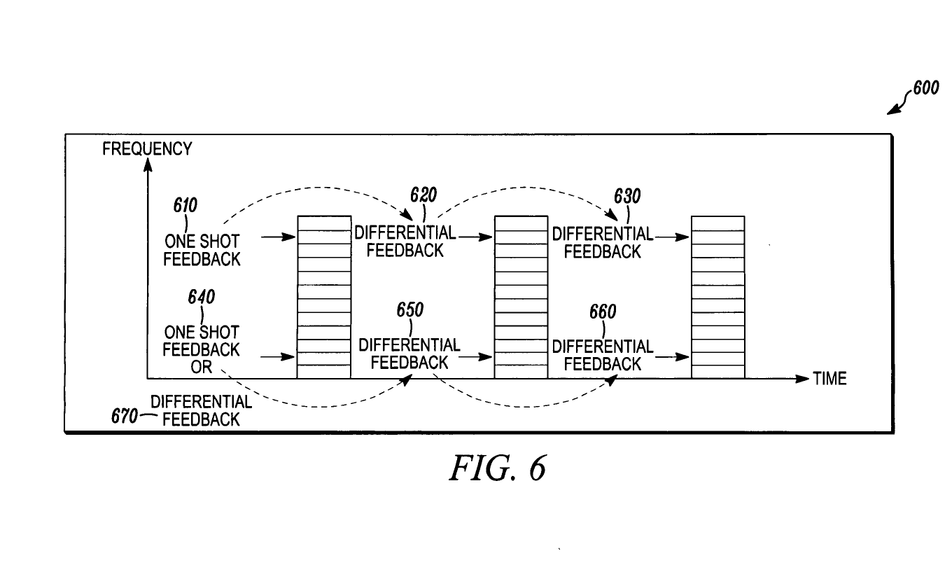

Looking now at FIG. 5 at 500 is illustrated an interpolation in the angle domain 510 and vector domain 520. It should be noted that the interpolation may be applied across frequency and/or time. When it is applied in the time domain, it may be used with a channel prediction technique. The beamforming matrix of a future time may be predicted through the prediction of the corresponding channel matrix. The beamforming matrixes between the one of the latest observed channel and the predicted channel may be computed from the interpolation. In addition, the interpolation may be applied with one-shot feedback or differential feedback. With the differential feedback, the feedback of two beamforming matrixes per subband can be run as shown in FIG. 6 at 600. At the beginning of each feedback period, a one-shot feedback is needed, which fully depicts the beamforming matrix without the previous feedback. The one-shot feedback is for one end of the subband and the feedback for the other end of the subband can be either one-shot feedback 610, 640 and 670 or differential feedback 620, 650, 630, and 660. The reliability is increased if one-shot feedback is used again because the beamforming may still partially work if one of the two one-shot feedbacks is corrupted. On the other hand, the differential feedback using the one-shot as reference reduces the feedback overhead. After the initialization with one-shot feedback, two differential feedbacks at a time are sent using the previous feedbacks as shown as 500 of FIG. 5.

For complexity reduction and performance enhancement, the receiver may select two beamforming matrixes close to the two ends of the subband and interpolate the beamforming matrixes only for a selected subset of subcarriers. For example, the receiver may partition the 72 subcarriers within the subband in 18-subcarrier group. The 18 subcarriers in each group are contiguous. The beamforming matrixes of the group center subcarriers are fed back or interpolated. The fed and interpolated beamforming matrixes are used for each group without further interpolation.

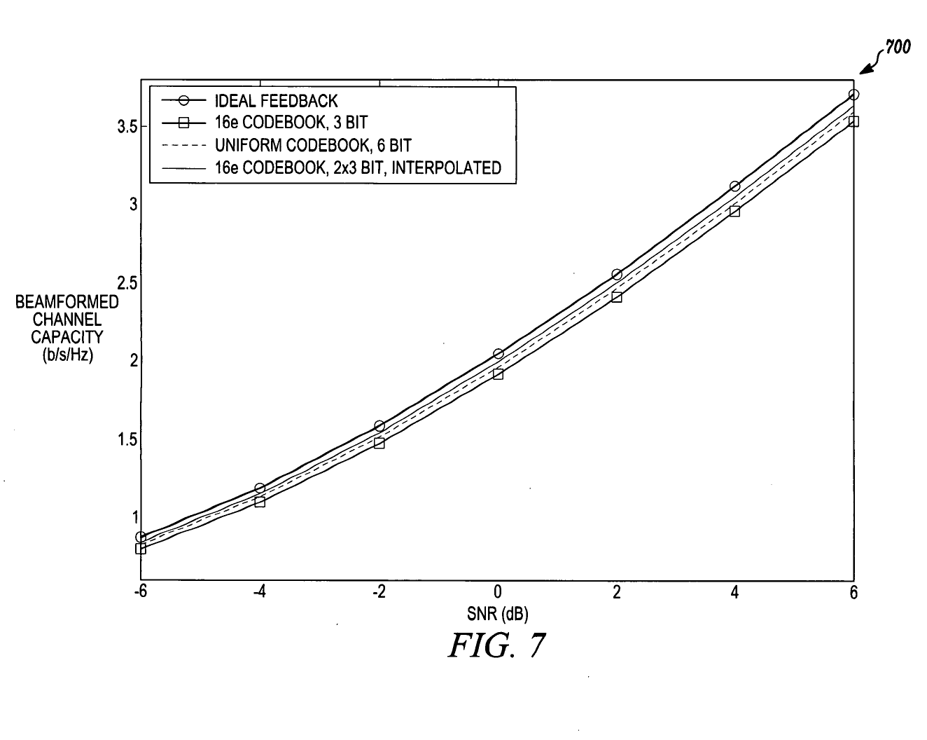

Looking now at FIG. 7 at 700 is a channel capacity comparison for weakly correlated 2×2 channels with a single stream transmission. Simulation is made for 2×2 single-user MIMO with 1 stream transmission and Pedestrian B eITU channels without spatial correlation. As a baseline, the 802.16e 3-bit codebook is used for the center subcarrier of the subband, i.e. the 37-th subcarrier. It is compared to two enhancement options that may be included in embodiments of the present invention. The first one increases the codebook resolution by using an optimal 6-bit codebook that has uniformly distributed codewords. The feedback is only for the center subcarrier and the performance is increased by 2.5%. However, adding the 6-bit codebook increases the number of codebooks and complicates the system design. The other option sends two feedbacks using the 802.16e 3-bit codebook as shown on at 300 of FIG. 3. The two feedback codewords are selected such that the beamforming gain with the interpolation is maximized. The second option increases the performance by 4.1% without adding a new codebook. Therefore, the second option is more desirable in view of both performance and complexity.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. An apparatus, comprising:
a transceiver adapted for multiple input multiple output (MIMO) beamforming and further adapted for communication with a receiver that feeds back to said transceiver a plurality of beamforming matrixes per subband and interpolates said beamforming matrixes across said subband.

2. The apparatus of claim 1, wherein said plurality of beamforming matrixes per subband are two beamforming matrixes for each end of said subband.

3. The apparatus of claim 2, wherein interpolation is made for at least one beamforming matrix in said subband using said two fed back matrixes and wherein beamforming matrixes vary across said subband and feedback indexes of said two beamforming matrixes at said two subband ends are selected jointly to take interpolation into account.

4. The apparatus of claim 1, wherein said interpolation is applied across a frequency or time domain and when it is applied in said time domain, it is used with a channel prediction technique.

5. The apparatus of claim 4, wherein at a beginning of each feedback period, a one-shot feedback is sent from said receiver which fully depicts a beamforming matrix without the previous feedback and wherein said one-shot feedback is for one end of said subband and feedback for another end of said subband is either one-shot feedback or differential feedback.

6. The apparatus of claim 5, wherein after initialization with said one-shot feedback, two differential feedbacks at a time are sent using previous feedbacks.

7. The apparatus of claim 6, wherein for complexity reduction and performance enhancement, said receiver selects two beamforming matrixes close to said two ends of said subband and interpolates said beamforming matrixes only for a selected subset of subcarriers.

8. The apparatus of claim 1, wherein there are multiple ways to interpolate said beamforming matrixes between said two fed back beamforming matrixes and wherein said beamforming matrix is unitary and on a Grassmann manifold and there are multiple curves connecting said two fed back matrixes and said interpolated matrixes are on a connecting curve, wherein each curve corresponds to a random realization of a channel variation and a curve which minimizes an average interpolation error is a geodesic connecting said multiple curves.

9. A method, comprising:
operating a transceiver as a base station (BS) in a wireless network that has been adapted for multiple input multiple output (MIMO) beamforming and further adapted for wireless communication with a receiver that feeds back to said transceiver a plurality of beamforming matrixes per subband and interpolates said beamforming matrixes across said subband.

10. The method of claim 9, wherein said plurality of beamforming matrixes per subband are two beamforming matrixes for each end of said subband.

11. The method of claim 10, further comprising interpolating for all beamforming matrixes in said subband using said two fed back matrixes and wherein beamforming matrixes vary across said subband and feedback indexes of said two beamforming matrixes at said two subband ends jointly are selected to take interpolation into account.

12. The method of claim 9, further comprising applying said interpolation across a frequency or time domain and when it is applied in said time domain, it is used with a channel prediction technique.

13. The method of claim 12, further comprising sending, at a beginning of each feedback period, a one-shot feedback from said receiver which fully depicts a beamforming matrix without the previous feedback and wherein said one-shot feedback is for one end of said subband and feedback for another end of said subband is either one-shot feedback or differential feedback.

14. The method of claim 13, further comprising sending two differential feedbacks at a time using previous feedbacks after initialization with said one-shot feedback,

15. The method of claim 14, wherein for complexity reduction and performance enhancement, said receiver selects two beamforming matrixes close to said two ends of said subband and interpolates said beamforming matrixes only for a selected subset of subcarriers.

16. The method of claim 9, wherein there are multiple ways to interpolate said beamforming matrixes between said two fed back beamforming matrixes and wherein said beamforming matrix is unitary and on a Grassmann manifold and there are multiple curves connecting said two fed back matrixes and said interpolated matrixes are on a connecting curve, wherein each curve corresponds to a random realization of a channel and a curve which minimizes an average interpolation error is a geodesic connecting said multiple curves.

17. A computer readable medium encoded with computer executable instructions, which when accessed, cause a machine to perform operations comprising:
operating a transceiver as a base station (BS) in a wireless network that has been adapted for multiple input multiple output (MIMO) beamforming and further adapted for wireless communication with a receiver that feeds back to said transceiver a plurality of beamforming matrixes per subband and interpolates said beamforming matrixes across said subband.

18. The computer readable medium encoded with computer executable instructions of claim 17, wherein said plurality of beamforming matrixes per subband are two beamforming matrixes for each end of said subband.

19. The computer readable medium encoded with computer executable instructions of claim 18, further comprising additional instructions that provide interpolating for all beamforming matrixes in said subband using said two fed back matrixes and wherein beamforming matrixes vary across said subband and feedback indexes of said two beamforming matrixes at said two subband ends jointly are selected to take interpolation into account.

20. The computer readable medium encoded with computer executable instructions of claim 19, further comprising additional instructions that provide applying said interpolation across a frequency or time domain and when it is applied in said time domain, it is used with a channel prediction technique.

21. The computer readable medium encoded with computer executable instructions of claim 20, further comprising additional instructions the provide sending, at a beginning of each feedback period, a one-shot feedback from said receiver which fully depicts a beamforming matrix without the previous feedback and wherein said one-shot feedback is for one end of said subband and feedback for another end of said subband is either one-shot feedback or differential feedback.

22. The computer readable medium encoded with computer executable instructions of claim 21, further comprising additional instructions the provide sending two differential feedbacks at a time using previous feedbacks after initialization with said one-shot feedback,

23. The computer readable medium encoded with computer executable instructions of claim 22, wherein for complexity reduction and performance enhancement, said receiver selects two beamforming matrixes close to said two ends of said subband and interpolates said beamforming matrixes only for a selected subset of subcarriers.

24. The computer readable medium encoded with computer executable instructions of claim 17, wherein there are multiple ways to interpolate said beamforming matrixes between said two fed back beamforming matrixes and wherein said beamforming matrix is unitary and on a Grassmann manifold and there are multiple curves connecting said two fed back matrixes and said interpolated matrixes are on a connecting curve, wherein each curve corresponds to a random realization of a channel and a curve which minimizes an average interpolation error is a geodesic connecting said multiple curves.

25. A system, comprising:
a transceiver adapted for multiple input multiple output (MIMO) beamforming and operable as a base station (BS) in a wireless network that conforms to an institute for electronic and electrical engineers (IEEE) 802.16 standard; and
a transceiver operable as a mobile station (MS) is said wireless network and operable to communicate with said BS, wherein said MS feeds back to said BS a plurality of beamforming matrixes per subband which interpolates said beamforming matrixes across said subband.

26. The system of claim 25, wherein said plurality of beamforming matrixes per subband are two beamforming matrixes for each end of said subband.

27. The system of claim 26, wherein interpolation is made for all beamforming matrixes in said subband using said two fed back matrixes and wherein beamforming matrixes vary across said subband and feedback indexes of said two beamforming matrixes at said two subband ends jointly are selected to take interpolation into account.
